(19) United States
(12) Patent Application Publication
(10) Pub. No.: US 2010/0261870 A1
(43) Pub. Date: Oct. 14, 2010

(54) METHOD FOR PRODUCING POLYETHER ALCOHOLS

(75) Inventors: Achim Loeffler, Speyer (DE); Eckard Schauss, Heuchelheim (DE); Matthias Schopohl, Dresden (DE); Dirk Meckelnburg, Limburgerhof (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/743,116

(22) PCT Filed: Dec. 16, 2008
(86) PCT No.: PCT/EP2008/067588

§ 371 Date: May 14, 2010

(30) Foreign Application Priority Data
Dec. 19, 2007 (EP) 07150105.0

(51) Int. Cl. C08G 65/26

(52) U.S. Cl. 528/425

(57) ABSTRACT

The invention provides a process for preparing polyether alcohols by adding alkylene oxides onto H-functional starter substances, of which at least one is solid at room temperature in a reaction vessel, by feeding the starting components continuously to the reaction vessel, which comprises preparing a paste from the solid starter substance and feeding this paste continuously to the reaction vessel.

The invention provides a process for preparing polyether alcohols by reacting alkylene oxides with H-functional starter substances.

Polyether alcohols are prepared in large amounts and have various uses. They are prepared usually by adding alkylene oxides onto H-functional starter substances. The addition is effected typically in the presence of catalysts, especially basic compounds, such as amines or alkali metal hydroxides, or of multimetal cyanide compounds, also known as DMC catalysts.

The main field of use of the polyether alcohols is the preparation of polyurethanes. According to the requirements on the properties of the polyurethanes, the polyether alcohols may differ greatly in their functionality, the molar mass and the starter substances used.

At present, polyether alcohols catalyzed with metal hydroxides are prepared predominantly in a batchwise or semibatchwise method. One exception is that of the DMC-catalyzed polyetherols. Since these catalysts promote the growth of short chains over longer chains, polyether alcohols can also be prepared by a continuous process. In this case, starter substance and alkylene oxides are metered continuously into a continuous reactor, for example a continuous stirred tank or a tubular reactor, and the finished product is removed continuously. Such processes are described, for example, in WO 98/03571 or in DD 204 735. These processes are restricted to DMC catalysts. By the DMC method, however, it is only possible to prepare polyether alcohols using liquid starter substances, as typically used for preparing flexible polyurethane foams. The addition of alkylene oxides onto solid starter substances or onto aromatic amines, as typically used as starter substances for preparing polyether alcohols for use in rigid polyurethane foams, is not possible with DMC catalysts.

It would be desirable to find a process improved over the currently customary semibatchwise process for preparing rigid foam polyether alcohols. The relatively large reactors needed in this procedure as a consequence of the long setup and emptying times are a crucial determining factor in the capital costs of the production plants. Moreover, valves, pumps and motors are highly stressed owing to the varying loadings. Specifically in the case of preparation of polyols based on sugar, powerful motors, transmission and stirrer axes are additionally needed in order to be able to mix the sugar mixture intensively with the alkylene oxides. The semibatchwise mode can additionally cause variations in the product quality from batch to batch.

During the alkoxylation too, the semibatchwise mode exhibits disadvantages. Usually, the sugar is mixed with a costarter, such as glycerol, diethylene glycol, triethanolamine, dipropylene glycol or water, to give a mixture or suspension. Subsequently, the alkylene oxide is metered in. Especially at the start of the process, however, the alkylene oxide is virtually insoluble in the sugar mixture/suspension. Therefore, high pressures initially occur in the reactor, and so the metered addition of the alkylene oxide has to be stopped under some circumstances. Furthermore, different degrees of alkoxylation are observed.

The switchover of this method to a more cost-efficient continuous method is not possible directly. Since the alkali-catalyzed propoxylation is a quasi-living polymerization, direct switchover of the semibatchwise alkoxylation in a backmixed reactor to a continuous method, as is possible, for example, in the case of DMC catalysis and is described in U.S. Pat. No. 5698012, is not possible. Instead, broad molecular weight distributions are observed in this case.

WO 00136514, WO 00136088 and WO 00136513 describe tubular reactors which can also be used to prepare rigid foam polyether alcohols. In order to achieve a full conversion here, the tubular reactors have to have a very long design.

Although the use of flow tube reactors would lead to narrow molecular weight distributions, the mixture or suspension composed of sugar and costarter can be pumped through the pipelines only at very great cost, if at all. The problems of the immiscibility of alkylene oxide phase and sugar phase and, consequently, the low reaction rates owing to low concentration additionally remain. In addition, numerous metering sites are needed in order to be able to operate the reactor safely and to control the reaction temperature.

A particular problem is the metered addition of the solid starter substance. Fundamentally, it is difficult to meter solid compounds into continuous processes, an additional factor in the preparation of polyether alcohols being the fact that the reaction proceeds under elevated pressure. Moreover, sucrose in particular tends to form lumps, which can lead to blockage of the feed lines. Sucrose, which is frequently used as the starter substance, is very abrasive, which leads to high wear in the reaction apparatus. These problems can also be solved only inadequately by mixing with other starters reactive with alkylene oxides, for example glycerol. Thus, the maximum amount for the addition onto such compounds which are liquid at room temperature is limited, in order not to allow the functionality of the polyether alcohols to fall too greatly.

It was therefore an object of the present invention to develop a preferably continuous process for preparing polyether alcohols by reacting starter substances solid at room temperature with alkylene oxides, which leads to products with a narrow molar mass distribution, which can be operated in a simple and operationally reliable manner, and in which the starter substances can be metered in continuously without any problem.

The object is achieved, surprisingly, by preparing a paste from the starter substances solid at room temperature and feeding this paste continuously to the reaction vessel.

The invention accordingly provides a process for preparing polyether alcohols by adding alkylene oxides onto H-functional starter substances, i.e. compounds comprising hydrogen atoms reactive with alkylene oxides, of which at least one is solid at room temperature in a reaction vessel, by feeding the starting components continuously to the reaction vessel, which comprises preparing a paste from the solid starter substance and feeding this paste continuously to the reaction vessel.

The invention further provides mixtures consisting of at least one H-functional compound, i.e. comprising hydrogen atoms reactive with alkylene oxides, solid at room temperature and at least one compound which comprises hydrogen atoms reactive with alkylene oxides and is liquid at room temperature, which are present in the form of a paste.

In a preferred embodiment, the process is performed continuously, i.e. the starting components are fed continuously to the reaction vessel, which is a continuous reactor, and the end product is withdrawn continuously from the reaction vessel.

In the reaction vessel, a steady state is established in the course of continuous performance of the process.

In the context of the invention, pastes are considered to be mixtures of compounds which are solid at room temperature with compounds which are liquid at room temperature, each of which comprise hydrogen atoms reactive with alkylene oxides. The compounds which are solid at room temperature are in the form of particles with an average particle size of less than 2 mm. These mixtures are pumpable.

In the context of the present invention, “pumpable” is understood to mean that the viscosity of the paste is not more than 100000 mPa.s, preferably 40000 mPa.s. Such a viscosity can already be achieved at room temperature. If this is not the case, the viscosity can be adjusted by increasing the temperature. The viscosity is determined here to DIN 53019.

The paste is preferably prepared by mixing the starter substance solid at room temperature with a compound liquid at room temperature.

The starter substances solid at room temperature which are used may in principle be any compounds which possess hydrogen atoms reactive toward alkylene oxides, also referred to hereinafter simply as active hydrogen atoms. They are preferably solid compounds with amino groups and/or hydroxyl groups. Their functionality is preferably at least 4.

Among the solid starter substances comprising hydroxyl groups with a functionality of at least 4, carbohydrates are of the greatest significance. The carbohydrates are preferably selected from the group comprising pentaerythritol, sorbitol, sucrose, cellulose, starch, starch hydrolyzates, sucrose and sorbitol being of the greatest industrial significance.

A further preferred group of H-functional compounds solid at room temperature is that of those which comprise at least one nitrogen atom in the molecule. In particular, these compounds comprise at least one primary or secondary amino group.

The solid starter substances with amino groups are preferably aliphatic and aromatic amines.

The compound which comprises at least one nitrogen atom and is used as the solid starter substance is preferably selected from the group comprising tolylenediamine (TDA), diphenylmethanediamine (MDA), urea, melamine and H-functional derivatives thereof, and also reaction products of amines with isocyanates such as TDI or MDI. In the case of TDA, the vicinal isomers are preferred.

The greatest industrial significant in this context is possessed by tolylenediamine (TDA) and melamine, and also H-functional derivatives thereof.

The solid starter substances can be used individually or in any mixtures with one another.

As described, the paste is prepared by mixing the starter substance solid at room temperature with compounds which are liquid at room temperature. The compounds liquid at room temperature are preferably compounds with active hydrogen atoms (also referred to as costarters).

The compounds liquid at room temperature, i.e. compounds reactive with alkylene oxides, may be low molecular weight compounds, especially bi- or trifunctional compounds with active hydrogen atoms, especially alcohols such as ethylene glycol, propylene glycol or glycerol. The greatest industrial significance in this context is possessed by glycerol.

In one embodiment of the process according to the invention, this compound is water.

In the case of polyether alcohols, end product, precursors with the same starter combination as but lower degree of alkoxylation than the end product, or alkoxylates with different starters or starter compositions than the end product, can be used. In a further preferred embodiment of the process according to the invention, the compound liquid at room temperature is an amine, especially an aliphatic amine, or an amino alcohol. Examples are ethylenediamine, ethanolamine, diethanolamine and mixtures of aromatic and aliphatic amines.

In one embodiment of the process according to the invention, the polyether alcohols used as compounds liquid at room temperature are an intermediate or the end product of the process according to the invention. This compound may be worked up, especially by the removal of water or the catalyst, but it may also be the crude product.

It is also possible to use bi- to tetrafunctional polyetherols with molecular weights between 200 and 600 g/mol as costarters. These polyetherols may either be catalyst-free or comprise catalyst. It is also possible here to use a different catalyst than that in the actual continuous process. It is therefore also conceivable to introduce a further catalyst into the reaction through the use of the alkaline additional polyetherol.

It is also possible to use a portion of the finished product, before or after the removal of the catalyst, as the costarter. This product recycling achieves the effect that the solid starter is dispersed/suspended in a larger mass of liquid starter.

Also possible are mixtures of at least two compounds from the groups listed.

The weight ratio of solid starter substance to the compound liquid at room temperature in the paste is preferably 1:99-99:1, more preferably 1:1-95:5 and especially 1:1-90:10.

In the case of sucrose, the weight ratio of solid starter substance to the compound liquid at room temperature in the paste is preferably between 90:10 and 1:1.

The paste is prepared by mixing the feedstocks. This can be done in the mixing apparatus known and customary for this purpose. When the viscosities are low under the conditions of paste preparation, simple stirred vessels are possible as mixing apparatus.

In a preferred embodiment of the invention, the paste is prepared in a shear force mixer or an inline mixer with rotor-stator principle.

A particularly preferred shear force mixer is an inline mixer, an extruder or a batch mixer with intensive stirrer unit. Especially when sucrose is used as the solid starter substance, the edges of the crystals are rounded off when a shear force mixer is used, such that the abrasive action of the crystals is greatly limited.

The average particle size of the compound solid at room temperature in the paste is especially less than 2 mm and greater than 2 μm and is preferably in the range between 2 μm and 1500 μm, preferably between 2-1000 μm and more preferably between 2-500 μm. The particle size and the particle size distribution were determined by means of laser diffraction. To this end, the paste was slurried in isopropanol and treated in an ultrasound bath for 2 minutes. Subsequently, a portion was taken for the measurement and transferred into the analysis instrument.

The preferred particle size can be effected by grinding or comminuting the starter substance which is solid at room temperature, by comminuting the solid starter substance during the mixing with the substance which is liquid at room temperature, or by comminuting or grinding the solid-liquid mixture.

The consistency of the paste should be such that it is firstly pumpable and secondly ensures a gas-tight closure when metered into the reactor.

The paste is fed into the continuous or semicontinuous reaction vessel by delivery by means of a pump against the pressure. The pump is, for example, a forced-delivery pump such as an eccentric screw pump, piston pump, helical piston pump or a screw spindle pump. In principle, the pressure increase for delivery into the reaction vessel can, however, also be ensured by any other suitable apparatus, for example an extruder.

The feed of the paste can also be delivered into the reaction vessel against the pressure with a gas. For this purpose, for example, noble gases, nitrogen or mixtures thereof are used.

In principle, the paste can be used in continuous and in semicontinuous semibatchwise processes for preparing polyether alcohols. In both cases, the paste is fed to the reactor as described above.

In a preferred embodiment of the invention, the paste is used in semibatchwise processes. The paste is metered in in parallel to the metered addition of alkylene oxide.

In one embodiment, product or intermediate is initially charged in the reaction vessel in such a way that mixing of the reaction mixture is ensured from the start. This mixing can be effected by stirring or by pumped circulation, optionally by external heat circulation or a combination of the two systems.

The paste can be supplied via the reactor lid, via the reactor base, via an immersed tube or by addition to the external circuit.

In a preferred variant, the metering rates of paste and alkylene oxide are selected such that the metered addition of the paste has already ended after the addition of 70-95% of the alkylene oxide, in order to ensure depletion of the solid starter substance to values below 1%, more preferably below 0.5% and most preferably below 500 ppm.

In semicontinuous processes, more rapid metered addition of the alkylene oxides can be effected when the paste is used.

In a further preferred embodiment, the paste is, as described, used for the continuous preparation of polyether alcohols.

The feeding of the starting materials of the continuous process according to the invention, i.e. of the starter substance mixture present in paste form and of the alkylene oxides, into the reactor is continuous. The catalyst and any further starter substance are likewise metered continuously into the reactor. The catalyst can also be added to the paste and be fed to the reactor in this form.

The reaction product is also withdrawn from the reactor continuously at the rate at which the reactants are added. The finished product can be discharged either directly from the reactor or via a lateral pumped circulation system.

The process according to the invention can proceed in all continuous reactors. Preference is given to tubular reactors, loop or circulation reactors, jet loop reactors with an internal heat exchanger, as described, for example, in DE 19854637 or in DE 10008630, or jet loop reactors with an external heat exchanger, as described, for example, in EP 419 419, and continuous stirred tanks (CSTRs), and the reactors listed connected in series (battery).

Preference is given to using backmixed reactors, i.e., for example, jet loop reactors and especially continuous stirred tanks.

In the case of use of continuous backmixed reactors, especially of stirred tanks, they may be arranged either individually or as a battery. The stirred tank battery consists preferably of at least two and at most five tanks. In this case, the reactants can be metered into all tanks of the battery.

The reactor size is guided by the necessary residence time and can be determined by the person skilled in the art as usual. It should preferably be selected at least such that the desired degree of alkoxylation is attained, and sufficient removal of heat can be effected.

The removal of heat in the exothermic alkoxylation can be effected by means of an external or internal heat exchanger, preference being given to external heat exchangers. In order to prevent residual sugar from being transported into the further process steps, the product can be subjected to a solid-liquid separation before entry into the transfer line or in the transfer line but before entry into the next reactor. The solid-liquid separation may be a filtration, a crossflow filtration or else a gravitational removal, for example by means of a hydrocyclone. The sugar-containing stream is recycled back into the reactor, while the sugar-free product stream is passed into the further process step.

In one embodiment of the process according to the invention, the finished polyether alcohol is withdrawn from the back mixed reactor.

In another embodiment of the process according to the invention, the continuous backmixed reactor or the battery is followed downstream by a further continuous reactor.

The catalysts used are typically basic compounds. They are typically tertiary amines, alkanolamines, amines which react under reaction conditions with alkylene oxides to give alkanolamines, and/or hydroxides of alkali metals and alkaline earth metals. Examples of aminic catalysts are dimethylamine, trimethylamine (TMA), tributylamine, triethylamine (TEA), dimethylethanolamine (DMEOA) and dimethylcyclohexylamine (DMCHA), imidazole and substituted imidazole derivatives, preferably dimethylethanolamine. Examples of the hydroxides are potassium hydroxide, sodium hydroxide, strontium hydroxide and calcium hydroxide. In one embodiment of the process according to the invention, the catalyst used is a mixture of an optionally substituted alkanolamine, especially DMEOA, and an alkaline earth metal hydroxide.

The catalysts mentioned can be used individually or in a mixture with one another. It is possible to use the same catalyst or different catalysts in the continuous backmixed reactor and in the further reactor.

The catalyst concentration may, based on the total mass of the polyol, be between 0.01 and 10%. If volatile amines such as TMA or TEA are used, it is additionally possible to remove them from the end product by means of stripping or distillation and to reuse them. The stripping can preferably be effected downstream of the backmixed reactor. The amine catalyst thus obtained can be recycled back into the continuous backmixed reactor.

The amine catalyst stripped off downstream of the backmixed reactor can also not be recycled back into the continuous backmixed reactor, but rather absorbed by the reaction medium by means of a suitable apparatus.

Unconverted alkylene oxide can also be stripped off downstream of the backmixed reactor and be fed back into an upstream reactor or be absorbed by the reaction medium by means of a suitable apparatus.

Preference is given to using aminic catalysts alone or in combination with the metallic catalysts. The advantage of the use of amines consists in the fact that no removal of the catalyst from the product is necessary.

The finished polyether alcohol is neutralized as usual, for example using mineral acids and/or carboxylic acids, and/or worked up by, for example, crystallization, ion exchange or adsorption. This step can be dispensed with if only aminic catalysts are used. It is additionally also possible, instead of a complete or partial removal of the catalyst, to perform merely a neutralization by means of organic acids such as acetic acid, lactic acid, citric acid, 2-ethylhexanoic acid, or mineral acids. Mixtures of acetric acid, lactic acid, citric acid and 2-ethylhexanoic acid can also be used.

For instance, it may be necessary to remove residues of alkylene oxides by stripping in columns, bubble columns or evaporators, such as thin film evaporators or falling film evaporators. At the same time, any volatile catalysts present, especially amines, can be removed.

The alkylene oxides and/or volatile catalysts removed at the end of the reaction battery or between two reactors within the battery can either be discarded or be reused as reactants. One possibility is to feed the substances as liquids after condensation. Another possibility is to introduce the gaseous reaction components into the reaction mixture using a suitable absorber, for example an absorber column. In the case of a battery, the alkylene oxide and/or catalyst recycled can be introduced either at the start of the reactor battery or between two reactors. The absorbent used may be the starter mixture or parts thereof.

The removal of the catalysts based on alkali metals or alkaline earth metals, whose necessity depends on the application, can be effected by conventional methods, for example crystallization, ion exchange or adsorption. In this case, the aim is products which comprise <200 ppm of alkalinity, preferably <100 ppm. Such processes should preferably be operated continuously.

The products can be stabilized by antioxidants if this is required, for example for reasons of application or of storage stability.

The process according to the invention is, as usual, carried out at temperatures between 50 and 180° C. The pressure during the reaction in the CSTR(s) is 1-40 barg, and the alkylene oxide concentration is below 20% by weight, preferably below 10% by weight, based in each case on the weight of all products present in the reactor. The pressure in the tubular reactor should be selected such that the alkylene oxides remain in liquid form for the most part but preferably completely. Under particular circumstances, for example in the case of use of vertical tubular reactors, a gas phase may be present.

The continuous process is started up, for example, by initially charging the finished product which is obtained from the continuous or a semibatchwise process. After the catalyst has been added, the starter paste and the catalyst and the alkylene oxide are metered in continuously. At high solids contents of the paste, it may be necessary to conduct the startup with a paste of lower solids content than corresponds to the product stoichiometry. The ratio in the starter paste can be shifted to ever higher solids contents within a short time.

As described, in another embodiment of the process according to the invention, the continuous reactor is followed downstream by a further continuous reactor. This may likewise be a backmixed reactor, but is preferably a tubular reactor. This is also referred to hereinafter as a postreactor.

In one embodiment, this postreactor serves for the complete conversion of the alkylene oxide still present in the effluent from the continuous backmixed reactor. In this embodiment, no alkylene oxide is metered into the postreactor. If required, further catalyst can be added to the reaction mixture before or during the reaction in the postreactor. This may be the same catalyst or a different catalyst than that in the continuous backmixed reactor.

In a further embodiment, as the postreactor, one or more backmixed reactors are connected downstream of the actual alkoxylation reactor, which are provided with internal or external heat exchangers in order to better remove the heat which arises in the postreaction. In this embodiment too, further catalyst can be metered into one or more postreactors. Combinations of stirred tank batteries and tubular reactors for depletion of alkylene oxide are also possible.

It is also possible to design the postreactor such that the solid starter is fully converted and no content of solid starter remains in the product. Alkylene oxide present in excess can then be stripped out.

In a further embodiment of the process according to the invention, a further molecular weight increase of the product from the continuous reactor is undertaken in the postreactor. To this end, further alkylene oxide if appropriate and further starter substance if appropriate, especially liquid starter substance, which may be alcohols, amines or alkoxylates thereof, are metered into the postreactor. In the case of a tubular reactor, the metered addition can be effected immediately at the entrance of the postreactor and/or at at least one metering site within the tubular reactor.

The tubular reactor which is preferably used as the postreactor can be designed in various ways. For instance, it is possible to use an empty tube. The tube can preferably be designed with internals, for example with random packings, static mixers with and without internal heat exchange areas and/or internals which lead to the formation of plug flow, for example commercially available SMX, SMR types from Sulzer, or as a helical tube reactor. The heat removal can be removed via the jacket, an internal cooling coil in the tubular reactor or by intermediate cooling with the aid of inserted heat exchangers or heat exchangers provided between tube sections. As described, it is possible for metering sites for starter, alkylene oxides and catalysts to be installed at one or more points in the tubular reactor. It is also possible to operate the reactor without additional metering sites. In this embodiment, the alkylene oxide needed for the reaction in the further reactor is added to the reaction mixture before entry into this reactor.

One factor guiding the residence times in the further reactors is the requirement to obtain a concentration of free alkylene oxide downstream of the reactor of below 10%, preferably below 5% and more preferably below 1%. On the other hand, the postreactor can be designed such that the residual content of solid starter is minimized, preferably to a residual content of less than 0.5% by weight. The flow rates in the tubular reactors should be selected such that radial mixing of the reaction medium is achieved, which has the consequence of only minor radial temperature and concentration gradients, if any. This can be achieved through a turbulent flow profile, internals such as random packings or static mixers, or a helical tube.

The reaction temperatures should, as in the continuous reactor, be selected such that, firstly, a high reaction rate can be achieved, and, secondly, there is no damage to the product.

The concentrations of free alkylene oxides at the feed points should be selected such that the removal of heat resulting from the reaction is ensured.

One conceivable embodiment would be a tubular reactor which is divided by sealed plates into separate sections, known as compartments, which are connected to one another by external pipelines, in which the effluent of the reactor passes through the compartments in succession from the first step of the reaction. No alkylene oxide is metered into this reactor. Such a reactor is described, for example, in WO 2007/009905.

In the case that the product is not neutralized, a stripping unit is connected downstream of the reactors. This stripping unit may be configured as a column, as a bubble column or as a stirred vessel. This removes unreacted alkylene oxide from the product under reduced pressure, preferably less than 200 mbar, most preferably less than 50 mbar. This process is promoted using a stripping gas, for example nitrogen or steam. When steam is used as the stripping gas, the pressure and the amount of steam should be established such that, as well as the desired residual alkylene oxide values, the target water contents in the product are also complied with. The residual water can optionally be removed in a separate reaction step under reduced pressure.

To prepare the polyether alcohols, compounds with at least one epoxy group, for example ethylene oxide, 1,2-epoxypropane (propylene oxide), 1,2- and 2,3-epoxybutane (butylene oxide) and higher homologous 1,2-epoxyalkanes or 1,2-epoxycycloalkanes, styrene oxide, etc., or any mixtures thereof, can be used. Particular preference is given to ethylene oxide and propylene oxide and mixtures thereof, especially propylene oxide.

The process according to the invention can prepare, in a simple and effective manner, polyether alcohols by a continuous process, without problems occurring in the metered addition of the solid starter substances. The contents of unconverted starter molecules, especially of the solid starters, are low, generally below 1% by weight, more preferably below 0.5% by weight and especially below 0.1% by weight.

The polyether alcohols prepared by the process according to the invention preferably have a molecular weight in the range of 200-2000 g/mol, especially 200-1000 g/mol.

The invention will be illustrated in detail by the examples which follow.

### EXAMPLE 1

### Continuous Preparation of a Paste Composed of Sucrose and Glycerol

In an inline shear force mixer from Lipp, a paste was prepared from sucrose and glycerol in a ratio of 80:20, in which the feedstocks were fed continuously to the mixer. The resulting paste was removed by means of an eccentric screw pump continuously into a reaction vessel which was under pressure (15 bar). The particle size distribution (PSD) was determined by means of laser diffraction. To this end, the paste was slurried in isopropanol and treated in an ultrasound bath for 2 minutes. Subsequently, a portion was withdrawn for the measurement and transferred to the analysis instrument. The PSD showed a spectrum of 1-1000 μm and the maximum of the distribution curve of the particle size around 20-50 μm. The crystal sugar had a PSD of 10-2000 μm before processing to the paste.

### EXAMPLE 2

### Continuous Reaction of a Sucrose/Glycerol Mixture with Alkylene Oxides

A mixture of sucrose and glycerol in a ratio of 80:20 was prepared in a contrarotatory extruder and transferred by means of a piston pump to a hydraulically filled continuous stirred tank with circulation system (2.8 l). The reaction vessel possessed a stirrer.

The temperature was regulated and controlled by means of an internal thermocouple. Dimethylethanolamine as a catalyst (0.75% by weight, based on the total amount of the starting materials) and propylene oxide were likewise added continuously to the reaction vessel (CSTR) by means of HPLC pumps. The total flow was 918 g/h. A portion of this mixture was supplied continuously to a postreactor, a tubular reactor with a volume of 1.1 l, in order to allow propylene oxide still present to be depleted. Unconverted propylene oxide was removed continuously in a downstream stripping vessel under reduced pressure (50 mbar). The reaction temperature was 110° C., both in the CSTR and in the postreactor. The product was not worked up. The reaction product which was obtained in steady-state operation (after 5 residence times) was analyzed. In the CSTR, a propylene oxide concentration of 5% was detected by means of an ATR-IR probe. The OH number of the resulting product was 468 mg KOH/g and the viscosity was 22500 mPas at 25° C. The content of residual sugar was determined by silylating the product and then analyzing it by means of gas chromatography. No residual sugar could be detected. The product was analyzed for foamability and exhibited virtually identical properties to the correspondingly prepared semibatchwise product.

### EXAMPLE 3

### Continuous Alkoxylation of a Sucrose/Glycerol/Polyol Mixture

A mixture of sucrose, glycerol and the polyetherol from example 2 in a sucrose:glycerol:polyetherol weight ratio of 60:20:20 was mixed continuously to a paste in a contrarotatory extruder and transferred by means of a piston pump to a continuous stirred tank according to example 2. The further reaction procedure remained identical and the reaction product from steady-state operation exhibited comparable analysis data in comparison to example 1: OHN=485, viscosity: 25200 mPas at 25° C. and residual sugar content of 200 ppm. In addition, a portion of the resultant finished product from the continuous reaction was fed to the starter mixture.

### EXAMPLE 4

### Continuous Alkoxylation of a Sucrose/Glycerol Mixture

A mixture of sucrose and glycerol in a ratio of 80:20 was mixed continuously to a paste in a contrarotatory extruder as described in example 1 and transferred by means of a piston pump to a continuous stirred tank according to example 2. DMEOA as a catalyst (0.75% by weight based on the total amount of the feedstocks) and propylene oxide were likewise metered into the reaction vessel (CSTR) continuously by means of HPLC pumps. The total flow was 1378 g/h. A portion of this mixture was fed continuously to a second reaction vessel, a CSTR with a volume of 1.4 I. Subsequently, the reaction mixture was fed to the postreactor (1.1 l), in order to allow propylene oxide still present to be depleted. Unconverted propylene oxide was removed continuously in a stripping vessel. The reaction temperature, both in the CSTRs and in the postreactor, was 110° C. At the outlet of the postreactor was positioned a pressure retaining valve, which released the reactor contents continuously into the product reservoir under reduced pressure (approx. 50 mbar). The product was not worked up. The reaction product obtained in steady-state operation (approx. 5 residence times) was analyzed. A propylene oxide concentration of 8.3% in the first CSTR and of 1.3% in the second CSTR were detected by means of an ATR-IR probe. The OH number of the resulting product was 455 mg KOH/g and the viscosity 20150 mPas at 25° C. The content of residual sugar was determined by silylating the product and then analyzing it by means of gas chromatography. No residual sugar could be detected. The product was analyzed for foamability and showed virtually identical properties to the semibatchwise product prepared correspondingly.

The hydroxyl number was determined to DIN 53420 and the viscosity was determined to DIN 53019.

To determine the residual sugar content, 200 mg of the polyether alcohol were admixed with 200 microliters of a solution of 2 mg of 1-dodecanol dissolved in 1 ml of pyridine, and then with 600 microliters of N-methyl-N-trimethylsilyltrifluoroacetamide (MSTFA). After the addition of the MSTFA, the sample was heated at 70 to 80° C. in a heating cabinet for 2 hours. The sample was cooled to room temperature and then injected into the gas chromatograph.

1. A process for preparing polyether alcohols by adding alkylene oxides onto H-functional starter substances, of which at least one is solid at room temperature in a reaction vessel, by feeding the starting components continuously to the reaction vessel, which comprises preparing a paste from the solid starter substance and feeding this paste continuously to the reaction vessel.

2. The process according to claim 1, which is performed in a backmixed reactor.

3. The process according to claim 1, which is performed continuously.

4. The process according to claim 1, which is performed semicontinuously.

5. The process according to claim 1, wherein the backmixed reactor is a stirred tank reactor.

6. The process according to claim 1, wherein the backmixed reactor is a stirred tank battery.

7. The process according to claim 1, wherein the backmixed reactor is a jet loop reactor.

8. The process according to claim 3, wherein the reactor is a tubular reactor.

9. The process according to claim 3, wherein the continuous backmixed reactor is followed downstream by a further continuous reactor.

10. The process according to claim 8, wherein the further continuous reactor is a reactor with plug flow.

11. The process according to claim 7, wherein the further continuous reactor is a tubular reactor.

12. The process according to claim 1, wherein the compound used as the solid starter substance has a functionality of at least 4.

13. The process according to claim 1, wherein the solid starter substance used comprises carbohydrates.

14. The process according to claim 1, wherein the carbohydrates are selected from the group comprising pentaerythritol, sorbitol, sucrose, cellulose, starch, starch hydrolyzates.

15. The process according to claim 1, wherein the solid starter substance used comprises compounds comprising at least one nitrogen atom.

16. The process according to claim 14, wherein the compound which comprises at least one nitrogen atom and is used as the solid starter substance is selected from the group comprising tolylenediamine, diphenylmethanediamine, urea, melamine and H-functional derivatives thereof, and also reaction products of amines with isocyanates.

17. The process according to claim 1, wherein the paste is prepared by mixing the solid starter substance with a compound liquid at room temperature.

18. The process according to claim 16, wherein the compound liquid at room temperature is water.

19. The process according to claim 16, wherein the compound liquid at room temperature is an alcohol.

20. The process according to claim 18, wherein the alcohol is selected from the group comprising glycerol, ethylene glycol, diethylene glycol, propylene glycol, butanediol or a polyether alcohol.

21. The process according to claim 16, wherein the compound liquid at room temperature is an amine.

22. The process according to claim 1, wherein the paste is prepared by mixing the solid starter substance with the compound liquid at room temperature in a shear force mixer.

23. A mixture consisting of at least one H-functional compound solid at room temperature and at least one H-functional compound liquid at room temperature, which is present in the form of a paste.
